(19) United States
(12) Patent Application Publication
(10) Pub. No.: US 2009/0012864 A1
(43) Pub. Date: Jan. 8, 2009

(54) COMPENSATION MODEL FOR NETWORK SERVICES

(76) Inventors: Sheldon F. Goldberg, Las Vegas, NV (US); Dennis J. Dupray, Golden, CO (US)

Correspondence Address: SHERIDAN ROSS PC, 1560 BROADWAY, SUITE 1200, DENVER, CO, 80202, US

(21) Appl. No.: 12/167,244

(22) Filed: Jul. 2, 2008

Related U.S. Application Data
(60) Provisional application No. 60/947,598, filed on Jul. 2, 2007.

(51) Int. Cl. G06Q 30/00

(52) U.S. Cl. 705/14

(57) ABSTRACT

A compensation model is disclosed for compensating a network service provider.

### RELATED APPLICATIONS

The present application claims the benefit of U.S. Provisional Patent Application No. 60/947,598 filed Jul. 2, 2007.

### RELATED FIELD OF THE INVENTION

The present invention relates to method and system for providing compensation to a network service provider via advertising and user fees for services.

### BACKGROUND

There are various techniques and strategies for providing services/products to users via a network such as the Internet, wherein the network nodes (e.g., websites) providing such services/products receive compensation by a combination of revenue streams, including:
(a) advertising, and offering free/reduced cost services/products as enticement for visiting the network node (i.e., and wherein such offerings are, e.g., subsidized by third parties such as advertisers), and/or
(b) the sale of services/products for a profit by the entity operating the network node.
   However, in many cases, it is difficult to consistently entice network users to repeatedly visit the network node and spend sufficient time at the node so that the volume of user traffic at the network node, and the demographics of the users trafficking the network node are sufficient to attract a substantial number advertisers to advertise on the network node. Accordingly, the revenue streams from (a) above may contribute only marginally to the profitability of the entity operating the network node.

The primary techniques or business models for enticing a large number of repeated user visitations to a network node (e.g., website) is to provide an interactive informational service that large numbers of users find repeatedly desirable and/or necessary. Examples of such successful business models are Internet search engine sites such as Google, social networking websites (e.g., www.facebook.com and www.myspace.com), various game websites, video website (e.g., www.youtube.com), and music websites. However, due to the competitiveness of network nodes for enticing users virtually all entities operating commercial network nodes need all the advantages and/or user enticements that are commercially feasible to maintain profitable revenue streams. Thus, in addition to providing free Internet searches, Google (as well as many other Internet sites) provide other free services/products such as browser toolbars, desktop search engines, notepads, pictures for computer monitor background screens, free games, instructional presentations (e.g., www.digg.com) and news reports. However, it would be advantageous to provide users with additional incentives for repeatedly visiting and expending additional time at a particular network node, such as an Internet website, by providing the capability to win cash prizes, free products or services, and/or access to products or services that are restricted from use by other users.

For at least some entities operating network (Internet) nodes, their business models also may include receiving compensation from users, wherein such compensation can be viewed as: (i) an activation fee, (ii) a license or subscription fee to use a service for, e.g., a predetermined amount of time, (iii) a membership fee, and/or (iv) a predetermined payment from which funds are withdrawn as the service is used such as in certain Internet wagering games. Such entities and/or the nodes they operate will be referred to hereinbelow as “user funded” nodes, sites, websites, services, entities, etc. User funded sites typically do not provide unrequested advertising to the users funding the website, or will present advertisements that are deemed very beneficial to a likely large number of the users funding the site. Accordingly, advertising revenues from such sites can be somewhat diminished. Some network site operators have developed a hybrid business model wherein some of the services at their network site are free to users, and the users are presented various types of advertising which may or may not be demographically targeted to the users, whereas other portions of the network site that are user funded and have little if any advertising. Thus, advertising revenue is derived from only the free services portion of the network site. However, it would be advantageous for a network site operator to be able to present more advertising and/or addition user enticements such as coupons, or reduced cost services/products to users funding the site to thereby generate, e.g., greater advertising revenue.

In some contexts, user compensation, where the users fund the site, may be considered illegal under the U.S. Federal Wire Act and/or other U.S. Federal Acts such as the “Unlawful Internet Gambling Enforcement Act of 2006,” (“UIGEA”). In particular, if the service provided by the network site includes betting, wagering, or other activity wherein there is a staking or risking of something of value upon the outcome of a contest of others, a sporting event, or a game subject to chance, upon an agreement or understanding that the person or another person will receive something of value in the event of a certain output occurring, then such U.S. laws may prohibit such services and/or user compensation therefor. Although such U.S. laws do not appear to be currently strictly enforced, the potential threat of enforcement is problematic. Basically, in the U.S. any service offered may be considered illegal to offer on a network such as the Internet if a user:
(1) provides consideration (e.g., funding, a bet or wager) for the service,
(2) the service can be considered to involve risk to the consideration provided by the user, and in particular, more risk than user skill, and
(3) something of benefit can be obtained such as a prize (cash or otherwise).
   Note that for such services to which UIGEA may be problematic (e.g., games of chance such as poker, blackjack, bingo, lotteries, roulette, etc.), a distinguishing characteristic that is different from games such as chess and checkers is that in games of chance there are events in an instance of the game wherein: (a) such events include risk for the player winning or losing something of value (e.g., a bet or wager) with another, and (b) the outcome of the event is not dependent solely on objective information common to all players. For example, a wager by a player in an online Internet chess game may not be considered a game of chance since all events in a game of chess are dependent solely on the objective common configuration of the chess board at any point in the game. On the other hand, for games such as poker, there is in any given game instance a substantial amount of information that is not common to all players (e.g., the unplayed cards in the card deck, and the cards in other players' hands) which substantially impact events during the game instance, and thereby substantially impact whether a player wins or loses something of value. However, many so called games of chance also include skill, and many individuals would assert a good deal of skill. For example, there are champion poker and blackjack players who will consistently win substantially more credits more times than other players, and more than mere random chance would indicate. Thus, such champions are prime anecdotal evidence that pure chance does not dictate outcomes of such games. In particular, it is believed that poker and blackjack (e.g., tournament blackjack which requires a careful analysis of each contestant's bet as well as an analysis of the cards each contestant is most likely to receive) require substantial skill. Alternatively, games such as purchasing lottery tickets and bingo are believed to require virtually no skill, and are indeed dominated by random chance outcomes.

To avoid violating the UIGEA, network sites offering games of chance have been forced to: (a) locate outside of the U.S., (b) wager points or tokens that have no intrinsic value, (c) play such games without the possibility of winning a prize of monetary value, and/or (d) play such games without the ability to wager at all. However, each of these options are undesirable, and in the case of (a) needlessly cause U.S. funds to be diverted to other countries. Moreover, none of these appropriately address the fact that many games of chance are substantially games of skill and should be treated as such.

Accordingly, it would be advantageous to be able to provide services (e.g., games), wherein a user skill aspect of the service is capable of being measured separately from random chance events related to the service. More particularly, when the service includes playing games of chance that include, e.g., generally recognized aspects of skill, it is desirable to play such games legally in the U.S., wherein prizes of monetary value can be won. For example, it is desirable for the skill portion of such games to be separately measured and used to award prizes to players having demonstrated a predetermined skill level.

Although Internet gaming in the U.S. is substantially done by Internet sites that are located in foreign countries (since such sites are then less subject to U.S. Federal laws), other games and services may also be subject to such U.S. laws such as UIGEA. For example, many “pay for play” games may be illegal under U.S. Federal law if there is an enticement to win a prize, wherein, e.g., a player pays a fixed amount upfront to play a game and wherein there is the possibility for the player to win a prize, e.g., a prize that is worth substantially more than the player's pay for play entry fee. It is believed that such U.S. laws may be enforced against any service having: (a) paying users and where there is some degree of risk (as may be determined by a U.S. court) is involved, and (b) where there is a prize that can be won wherein the prize is worth more than the user paid upfront. Accordingly, it would be advantageous to provide enticements to network (Internet) users when playing games having upfront payments and that involve prizes without violating such U.S. laws.

Referring particularly to Internet sites having free games wherein game tournaments are provided, there can be a significant problem with a user/player entering the same tournament multiple times by entering under a multitude of different user names and thereby significantly increasing his/her chances of winning the tournament (and any corresponding prize). For example, even if distinct email addresses are required for each tournament player, it is relatively easy for a single user to obtain a plurality of email accounts. Accordingly, since a person's email address is the method usually used by a network site to determine whether an entrant has previously registered, multiple entries by the same person can significantly increase his/her odds of winning the tournament. Accordingly, it would be advantageous to inhibit tournament players of, e.g., free tournaments, from easily entering such tournaments under multiple user names, and thereby inherently reducing the attractiveness of the tournament to other users. Moreover, since the revenue that the network site operator obtains from the tournament is likely to be from offering advertising and/or advertiser services/products that are based upon the number of “distinct” users, it is problematic for the operator to assert with any certainty to his/her advertisers that the advertisers' ads are being presented to a sufficient number of distinct users. That is, the ability of a game site operator to assure that the number of players it represents to its advertisers is accurate and that few, if any, entrants are duplicates has been problematic.

If and when there is a change in the law that allows on-line gambling in the U.S., there remains the need to provide unique methods of recruiting users to both free as well as pay for play type games. Since a “free” game is one of the ways to attract users, a combination of free and pay for play style games is believed to be attractive to users and commercially viable for network site operators. Thus, the problems addressed in this disclosure will remain issues to be resolved, whatever the state of the law.

The advantages identified hereinabove are provided by the disclosure hereinbelow.

### SUMMARY

The present disclosure is directed to a novel collection of business techniques or business models (also referred to as a “compensation model” herein) for addressing the problems, and attaining the advantages, outlined in the Background section hereinabove. In particular, the present disclosure describes a method and system for receiving compensation for network (e.g., Internet) services, wherein such services may require users to pay or fund a first service (e.g., a “user funded” service as described in Background section hereinabove), and regardless of what elements of risk (if any) are involved in performing or participating in the user-funded service, such users may become eligible to legally win a prize of, e.g., monetary value associated with an instance of a service (this service referred to herein as a “prize-winning service”) once one or more proficiency criteria in the user-funded service is demonstrated. Moreover, the present disclosure directed to utilizing the user-funded service whether or not the prize-winning service is available. In particular, the user-funded service may be configured so that a user's funds are only retained (or charged to the user) by the user-funded service when the user fails to satisfy a predetermined criteria related to the service. For example, if the service includes the playing of games, then the user-funded service may only retain/charge the user when the user does not play a minimum number of games, a minimum amount of time, demonstrate a minimum indication of game proficiency (e.g., accumulate a minimum number of game points, beat one or more other players—possibly robot players, place sufficiently high in a game tournament, etc.). However, it is within the scope of the present disclosure that other services, instead of games, may be provided for the user-funded service and/or a related prize-winning service. For example, such a service may be an Internet search engine, or an instructional video site wherein a user is only charged for using the service if, e.g., the user does not access the service sufficiently frequently during a particular time period, or does not interact with the service in a particular by the end of a particular time period (e.g., the user does not contribute to an appropriate product evaluation, does not contribute an appropriate instructional video, does not contribute appropriate assistance to other users, and/or does not contribute appropriate music recommendations, etc.), then the user is charged a fee for accessing the service, and/or a previously paid user fee is refunded.

Regarding, the prize-winning service, such a service may be operated by the same service as the user-funded service, or each such service may be operated by separate operators, wherein user participation in an instance of the prize-winning service may be free to the user having established a proficiency/eligibility in the user-funded service. Additionally, since the users competing for prizes (in instances of the prize-winning service) are known, e.g., via credit/debit card network transactions when paying for the user-funded service, the present compensation model introduces a greater measure of integrity or fairness into user competition in that restrictions on a user participating, e.g., under aliases, to thereby favorably skew odds in his/her favor of winning can be enforced.

In a first collection of embodiments of the present compensation model for receiving an opportunity to win prizes, each of a plurality of users are required to provide an initial activation fee or deposit to access a service (a user-funded service herein, and which may be, e.g., a game or contest). Subsequently, each of the users can obtain a refund of his/her activation fee or deposit if and when the user, e.g., achieves a certain or predetermined level of proficiency (i.e., skill) related to the user-funded service. That is, after reaching such a level of proficiency, the user's activation fee or deposit is returned to the user. In one embodiment, exactly the user's activation fee or deposit is returned, no more and no less. Note that if more than the user's activation fee or deposit were returned, then the excess amount might be legally considered as a prize in certain circumstances, and thus problematic in the context of, e.g., U.S. gaming laws. Moreover, the repaying of an amount that is less than the user activation fee or deposit may also be problematic in that the ability for the user to activate additional services (e.g., a “prize-winning service”), wherein prizes of monetary value can be won, may be considered as a service that the user has also paid for as well.

In this first collection of embodiments, once the user has attained a certain level of proficiency or skill in a particular user-funded service, and the user's fee or deposit has been returned, the user may be then eligible to win one or more prizes of monetary value related to subsequent instance of the prize-winning service without paying any further fees or deposits. Accordingly, claims that there has been compensation (consideration) paid to the network site operator for winning a prize of monetary are believed (at least in some instances) to be avoided. Thus, the initial activation fee or deposit may be properly considered as a fee or deposit for the user gaining expertise with the user-funded service (or, e.g., similar services), and such consideration from the user to the site operator is not at risk for winning a prize since such consideration was used for a service for which no prizes of a monetary value were offered, and user's fee or deposit is entirely refunded when the user reaches an appropriate level of proficiency or skill.

In another embodiment of the present compensation model, users provide nothing of value initially to participate in the user-funded service. Instead, a user(s) enters into an agreement with the operator of the user-funded service, wherein the user(s) agrees that, e.g., after a given amount of time (such as a week, six weeks, or six months), if the user does not satisfy certain service related criteria (e.g., one or more proficiency criteria), then (and only then) will the user be charged for using the service. Accordingly, the user may be required to provide credit card information when registering to access the user-funded service. However, no expense is incurred by the user unless the agreed to one or more service related criteria are not satisfied. Note that such service related criteria may be that the user agrees, e.g., to access the service at a given frequency (e.g., once a day), to access the service for a given number of hours per week, to sponsor at least one new service user per month, etc.

In some embodiments of the compensation model (including some of the first collection described above), users having reached a predetermined proficiency level (or satisfies certain service related criteria) may pick and choose which from among a plurality of instances of a prize-winning service (which may be an instance of the user-funded service or another service) that are provided at different times, or at different geographical (or network) locations. Alternatively/additionally, such users may be able to select from among additional instances of the prize-winning services, wherein such instances are offered at substantially the same time. Thus, a user having reached a particular proficiency level (or satisfied certain service related criteria) in a user-funded service may enter an instance of a free prize-winning service for winning prizes immediately after demonstrating his/her proficiency (or satisfying certain service related criteria), or the user may elect to participate in such a prize-winning service for winning prizes at a later date.

In some embodiments of the compensation model (including some of the first collection described above), users may activate or use the user-funded service as much as they desire (e.g., play as many games as they desire), and/or take as long as they desire (e.g., within a reasonable amount of time, e.g., six months or a year) to demonstrate that they have reached an appropriate skill or proficiency level for qualifying to participate in a corresponding instance of a prize-winning service wherein there is an opportunity to win prizes without the users risking anything of value (e.g., money). In some embodiments, users may be required to demonstrate their proficiency (or satisfying certain service related criteria) within, e.g., a predetermined time, and at the end of the predetermined time all users will have their activation fees or deposits refunded. However, only those users satisfying the predetermined proficiency levels will be eligible to enter the additional instances of the prize-winning service(s) for winning prizes.

In some embodiments of the compensation model (including some of the first collection described above), a user may circumvent activating the user-funded service for demonstrating his/her proficiency or skill by providing alternative evidence that the user has the desired proficiency or skill to participate in the free prize-winning service(s) that can result in the user winning a prize(s) of monetary value. In particular, a user may show his/her proficiency or skill by presenting evidence of such proficiency in ways other than providing the activation fee or deposit and participating in the user-funded service. In particular, in a gaming context (e.g., game of chance also having an element of skill), a user may provide evidence that he/she is proficient by identifying, e.g., a casino or other establishment (or network site) along with date that the user demonstrated an appropriate level of proficiency in the user-funded service. For example, if the user-funded service is the game of scrabble, and a user is able to verify that he/she has won a well known scrabble contest, and/or has a National Scrabble Association rating above a particular value, then the user may be considered sufficiently proficient for participating in a corresponding free prize-winning service such as a scrabble contest or, e.g., another word related competition. In one embodiment, such a user may be required to provide a deposit for participating in the prize-winning service, and if the user wins a prize then the user may have to provide his/her evidence of proficiency before receiving the prize. Accordingly, if the evidence cannot be verified, then his/her deposit is forfeited. In one embodiment, when the user-funded service is a game of chance, a user may assert that he/she has won, e.g., certain amount of money, a tournament for the game of chance, or won a certain number of games at a particular casino or during a particular time period as a way of demonstrating his/her proficiency at the user-funded service. Moreover, the network site operator may contract with one or more casinos (online or otherwise) so that both the casino and the operator's site each advertise one another's gaming services so that players considered proficient at such a casino may be automatically considered proficient on the operator's network site. In addition, when the user-funded service is (or includes) a game, a user may attain the predetermined level of proficiency by playing against a software program (e.g., a robot) that is programmed to play at least a desired predetermined proficiency level.

In a second collection of embodiments, the present compensation model requests users to provide an activation fee or deposit for using a user-funded service, and once all users have used the user-funded service as intended (e.g., played the required number of games within a predetermined time period), all users have their activation fees or deposits returned them, and additionally those users demonstrating the most skill (e.g., by winning the most games) are also provided with prizes in addition to receiving their refunds. Note that a fundamental difference between the first and second collections of embodiments is that in the first collection of embodiments, the site operator has the opportunity to at least recover some of his/her expenses for enhancing the skills or proficiency of the users since it is likely that not all user's will reach the predetermined proficiency level. However, in either the first or second collection of embodiments, the upfront funding (and/or providing credit card information for potentially charging) for accessing the user-funded service is likely to deter a user from duplicatively registering a large number of times and thereby skewing the odds in the user's favor of winning a prize. In particular, since each such registration may be by credit/debit card, duplicate registrations in a user-funded service (for eventually participating in an instance of a prize-winning service) may be inhibited to a great extent by preventing registration (and payment of the activation fee or deposit) from each user whose name is identical (or substantially so) to another registered user at, e.g., a same geographical (or network) address as provided by the credit card information.

In one embodiment, the user-funded service and/or the prize-winning service referred to hereinabove may be an online Internet game service wherein the game(s) may be poker, chess, checkers, monopoly, hearts, spades, euchre, canasta, blackjack, scrabble, video games (e.g., war games), racing games (e.g., auto racing games), trivia games, Internet search games and/or investment games (e.g., stock market investment competitions). More generally, such Internet games and/or contests may be single player games (e.g., where a user plays against a network site or house), multi-player games (e.g., multi-player Internet video/simulation games, or games based on geographical locations of players), games that include an element of chance (e.g., casino card games), board games, and/or mystery solving games.

In one embodiment, the level of proficiency may be one or more of: obtaining a predetermined number of points (e.g., chips in one or more poker games), winning a certain number of game instances (e.g., winning a predetermined number of scrabble games), winning more games than another user (e.g., winning the most hearts games in a hearts tournament), obtaining a predetermined number of points from winning games against other players of a particular skill level (e.g., winning chess games against chess players having an Elo rating system above a particular rating), and/or beating a predetermined number of players having a particular proficiency or skill level.

In another embodiment, the user-funded service and/or the prize-winning service referred to hereinabove may allow users to compete in the creation of designs such as: landscape designs, auto designs, house designs, etc. In another embodiment, the user-funded service and/or the prize-winning service may allow users to compete in the creation of musical compositions, user produced videos, etc., wherein the level of proficiency is determined by, e.g., a predetermined group of judges for judging user entries. In one embodiment, the predetermined group of judges may be the users themselves who have paid the activation fee or deposit. For example, if the user-funded service includes a design or art competition, then each user may register by agreeing to provide credit card information which may be charged in the event that the user's design/art is eliminated from the competition, and not charged in the event that the user's design/art is not eliminated. Moreover, user's whose design/art is not eliminated may then be eligible to enter a free contest (design, art, or otherwise) wherein one or more contestants may win prizes of substantial value.

In one embodiment, the user-funded service may be provided by a third party network site. For example, if a third party website provides a service for which a proficiency level can be determined, then once the users pay a fee (or agree to potentially paying a fee) to the operator of the site providing the present compensation model (for determining, monitoring and/or verifying that users performed the service to a particular proficiency level on the third party network site), the users reaching the particular proficiency level (on the third party network site) then would be allowed to win prizes in free instances of a prize-winning service. Moreover, the prize-winning service may also be provided by a third party site or a site owned or controlled by the operator of the site providing the present compensation model. Thus, an operator for a network site providing an embodiment of the compensation model need not actually provide the user-funded service or the prize-winning service. Accordingly, the operator of the compensation model provides a brokering service for the user-funded services and the prize-winning services.

In one embodiment, the activation fee referred to hereinabove may be considered as a deposit, wherein such a user's deposit is forfeited if the user does not reach the predetermined level of proficiency (or satisfies certain service related criteria), e.g., within a predetermined time limit, within a predetermined amount of service activation (e.g., a number of games played, or a number musical compositions submitted), or the like.

In one embodiment, the determination of proficiency (or satisfaction of certain service related criteria) for the user-funded service may be assessed by the amount of time a user has spent interacting with the user-funded service. For example, regardless of whether a user has met a proficiency level (or satisfaction of certain service related criteria) according to any other measurement, the user may be assumed to have a sufficient proficiency if the user has interacted with the user-funded service, e.g., a predetermined amount of time, a predetermined number service sessions, and/or a predetermined number instances of the service (e.g., games played). Where the user-funded service includes a game, a user may be deemed to have reached the predetermined proficiency level if the user has won a predetermined number of instances of the game, or placed above a certain portion of the users in a ranking of the users, or won a predetermined percentage of the games played once at least a certain number of game instances have been played, or played a predetermined (likely much larger) number of games, or played a predetermined amount of time. Moreover, for each different level of proficiency demonstrated (assuming, e.g., there are multiple levels of proficiency monitored), the user may be allowed to activate a prize-winning service for winning prizes associated with the level of proficiency demonstrated.

In one embodiment, there may be more than one proficiency level for users to attain. Thus, when a first proficiency level is obtained, a user may opt to receive his/her activation fee or deposit, and then participate in a corresponding instance of a prize-winning service. Alternatively, the user may instead opt to proceed to a second level of proficiency, and upon reaching such a second level, opt for receiving his/her activation fee or deposit (or at least the equivalent in products or services), and then participate in a corresponding instance of a prize-winning service for winning a more substantial prize. In one embodiment, a first portion of a user's activation fee or deposit may be refunded at a first proficiency level, and an additional portion may be refunded at an additional proficiency level. Thus, users may be paid to enhance their skills (or satisfy certain service related criteria).

In one embodiment, the present compensation model may be used in providing a network service (user-funded service and/or the prize-winning service), wherein the users registering for the service may become voting members for determining the proficiency level for other registered users. For example, the user-funded service (or instance thereof) may be a graphic design contest, wherein each registered user can enter up to three designs, and each member is allowed to vote once for no more than 10 designs not submitted by the member. Accordingly, the members whose graphic designs are voted to have obtained the predetermined proficiency level, would have their activation fee or deposit returned, and then be eligible to participate in, e.g., a free contest for winning a prize (the free contest may be another graphic design contest). Note that the proficiency level for the present embodiment may be, e.g., receiving a predetermined percentage of the votes (e.g., 5%), or receiving at least a predetermined number of votes, or receiving enough votes to be one of a predetermined number of top vote obtainers (e.g., the designs gathering the 100 highest numbers of votes).

Moreover, as discussed further hereinbelow, an important aspect of at least some embodiments of the compensation model is the fairness of a contest associated with the user-funded service and/or the prize-winning service. For example, assuming names and addresses of users paying the activation fee or deposit is checked against other users that previously paid the activation fee or deposit for duplicates, such a procedure can be used to prevent a user from registering a large number of times and thereby distort the user's chances of attaining a particular proficiency level and/or subsequently winning a prize. In particular, requiring an activation fee or deposit can substantially reduce a user receiving an unfair advantage since when each user pays for each registration, and the mechanism for such payment via a network (Internet) transaction requires the user to identify him/herself via, e.g., a credit card or a debit card. Additional/alternative, identification may be by a cell phone or other phone number that is acquired by the network site, wherein such additional information may used to verify a user's identity.

In another embodiment, the user's activation fee or deposit may be designated as a gift to a charity. Thus, the site operator may not receive any compensation from the user-funded service.

In at least some embodiments of the compensation model, network site operators may receive compensation for either or both of the user-funded service and/or the prize-winning service from advertisers whose advertisements are presented to users during their participation in an instance(s) of the user-funded service and/or the prize-winning service. In one embodiment, advertisers for the user funded and/or prize-winning service instances may sponsor one or more users to participate in the user funded and/or prize-winning service. For example, a well known poker player, or an especially proficient poker player, may be sponsored by an advertiser to play in a free poker tournament for winning prizes, and each poker hand won by a user from the well known poker player (wherein, e.g., the well known player does not fold) may contribute to the user winning a prize that is above and beyond merely winning the poker hand.

Additionally/alternatively, an advertiser may sponsor a user, e.g., based on proficiency information of the users, wherein the user's potential charges in the user-funded service are paid (if necessary) by an advertiser selected by the user. In one embodiment, instead of (or in addition to) paying an activation fee or deposit, a user may select one or more advertisers from which to receive advertising and/or from which not to receive advertising. In the case where a user does not pay the activation fee or deposit, e.g., when it is paid by an advertiser or sponsor, the user may win prizes in the so called user-funded service, and there need not be a separate prize-winning service instance. For example, a beverage company might sponsor a prize of free beverages for a year in an instance of a prize-winning service, and the beverage company may provide the majority of the ads presented during one or both of the user-funded service and/or the prize-winning service instances. However, note that it may still be advantageous for users to pay an activation fee or deposit (or at least providing card/debit card information) in order to reduce the possibility of a user receiving unfair advantage in winning prizes as discussed hereinabove. Advertisers may provide prizes throughout the game as well as provide a prize to the ultimate winner(s).

In one embodiment, a game of skill is combined with a game of risk so that the combination creates a new game requiring an entrant to use skill to be recognized as a winner.

In one embodiment the users may choose the advertiser(s) or the advertising area of interest that they desire to view. The ability of a player to recall information in the advertising presented during the contest may be used to determine the winner.

In one embodiment, there may be a combination of a charitable contribution and a deposit or payment that is for a predetermined purpose e.g., paying for an item of information or the ability to cast a vote.

In one embodiment, an organization for which the user is a member may provide a deposit for a user-funded service to assist the user in attaining a higher proficiency level e.g., a dating service organization may provide its members with the opportunity to learn and exhibit their proficiency in email etiquette via an instance of a user-funded service.

In one embodiment, the present compensation model can be used for providing more integrity to Internet chat rooms since users would be required to pay an activation fee or deposit which may be returned to the user after, e.g., there are fewer than a predetermined number of complaints about the user.

Additional features and benefits of the present disclosure are provided hereinbelow. The present SUMMARY section is not intended to provide a comprehensive description of the novel aspects provided herein. The claims provided hereinbelow are intended to define the novel features for patent protection. Moreover, to the extent that one of ordinary skill in the art can modify and/or combine various aspects of the present disclosure, such modifications and/or combinations are within the scope of the present disclosure from which patent protection can be sought. Accordingly, any operable novel combination of the embodiments of the user-funded service (and its operation), the prize-winning service (and its operation), and the compensation model (and its operation) disclosed herein may be recited in the claims hereinbelow.

### DETAILED DESCRIPTION

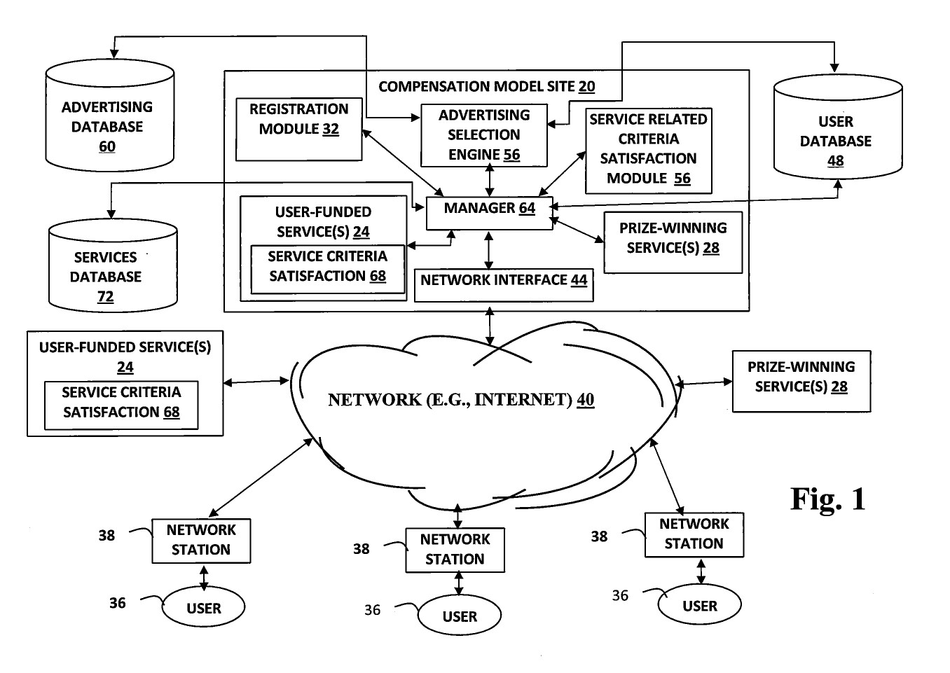

FIG. 1 shows a high level diagram of one embodiment of the compensation model which is accessible to users of the Internet. A compensation model network site 20 is provided for coordinating and/or controlling both the associated user-funded service(s) 24, and the associated prize-winning services 28. Note that the user-funded service(s) 24 and the prize-winning service(s) 28 may be incorporated into (more generally, accessible via) the compensation model site 20, or alternatively/additionally, such service(s) 24 and/or 28 may be substantially independent of the compensation model site 20. In particular, the service(s) 24 and/or 28 may be operated or controlled by a different entity than the one that operates or controls the compensation model site 20.

The compensation model site 20 further includes (or provides access to) a registration module 32 for registering users 36 for accessing both the user-funded service(s) 24 and the prize-winning service(s) 28. The registration module 32 is interactive with each user (via the corresponding user's network station 38) to be registered via network 40 communications with the network interface 44. The registration module 32 interacts with each user 36 for obtaining, e.g., user identification information, including name, address, email address, date of birth, and credit/debit card information. Additionally, the registration module 32 may request additional user information such as the types of network services in which a user 36 is interested in participating, e.g., games of skill, games of chance, judged contests, development of user expertise in some area, etc. The registration module 32 may use the obtained registration information obtained from a potential user 36 to access the user database 48 for determining if there is a user already registered that may identify the potential user 36. Note, that data may be provided in the user information stored in the user database 48 indicating whether there is the possibility that the user has registered more than once with the compensation model site 20. However, generally, such user information may be only used to prevent the dispensing of a prize or winnings if it is determined that a user 36 entered the same instance of a prize-winning service under multiple user registrations.

The compensation model site 20 further includes (or provides access to) a service related criteria satisfaction module 52 which collects information on how each user 36 is progressing toward satisfying constraints related to the one or more user-funded services which the user 36 has committed to fulfilling. Such service related criteria may be specific to the one or more user-funded services 24 for which a user 36 has contracted. Such user data regarding satisfaction of service related criteria may be provided to the module 52 from a user-funded service 24 that the user 36 is able to access. However, if such user-funded services 24 are incorporated into (or operated by the operator of the compensation model site 20), then at least some of the generic service related criteria (e.g., time interacting with a user-funded service 24) may be tabulated directly by the module 52.

The compensation model site 20 also includes (or provides access to) an advertising selection engine 56 for providing advertising to be displayed at network stations 38 when user-funded services and/or prize-winning services are being accessed by the users 36 of the network stations 38. For user-funded services 24 and/or prize-winning services 28 incorporated into (or operated by the operator of the compensation model site 20), such advertising may be directly joined with service presentations prior to transmission from the compensation model site 20 to a user network station 38. However, for user-funded services 24 and/or prize-winning services 28 incorporated into (or operated by the operator of the compensation model site 20), such advertising may be transmitted in a manner similar third party Internet advertising agencies such as DoubleClick®, wherein a service transmission received at a user network station 38 may include information for generating an additional request for advertising information from, e.g., the compensation model site 20. Note that the advertising selection engine 56 may select advertising from the advertising database 60 for presenting to users 36, and such advertising typically includes one or more hyperlinks that allow a user 36 viewing the advertising to activate the hyperlink and thereby receive additional advertising information from typically a corresponding advertiser's network site (e.g., Internet or website) as one skilled in the art will understand. However, such additional advertising information can also include alternative user interface techniques for presenting at least portions of the additional advertising information to the users 36. For example, such additional advertising may be transmitted (e.g., joined with service related information) so that when (if) a user 36 merely positions his/her pointing device (“mouses over” with e.g., a mouse or trackball) on or over a display of an advertisement, then additional information is presented, and such additional information may be particularly targeted to the user; e.g., a sale of merchandise in which the user's profile indicates the user is interested. In one embodiment, there may be a designated portion of the user's network station display in which such additional advertising information is presented when the user mouses over a displayed advertisement. Such a designated portion may be similar to a news stream across, e.g., top or bottom portion of the network station display. In one embodiment, the advertising selection engine 56 attempts to match advertisements in the advertising database 60 with user profiles stored in the user database 48. A description of such a matching operation is disclosed in U.S. Pat. No. 6,712,702 fully incorporated herein by reference. Thus, advertising may be targeted to selected users 36 according to their interests, needs, life styles, etc.

The compensation model site 20 also includes a manager 64 for controlling and/or coordinating the exchange of information between the users 36 and the modules 24, 28, 32, 52, and 56 of the compensation model site 20. Moreover, the manager 64 may join advertising to service presentations prior to transmission to a user(s) 36. Thus, since each of the user-funded services 24 and the prize-winning services 28 are likely to be interact with each of the users 36 (via their corresponding network stations 38), the manager 64 may use display frame data for determining how to join selected advertising for display at a user's network station 38.

Regarding the user-funded service(s) 24 in more detail, this module/network site may include a service related criteria satisfaction module 68 for determining and monitoring the progress of a user 36 toward satisfying the agreed to one or more criteria in order to use the user-funded service for free (e.g., have the user's service deposit refunded, or prevent the charging of a credit/debit card of the user's). Thus, such a module 68 may monitor a user's interactions with the user-funded service for, e.g., an increase in proficiency of the user, an amount of time the user interacts with the service, a frequency with which the user interacts with the service, a number of submissions to the service (such as art, music or informational submissions, etc.). Accordingly, the module 68 may periodically provides the service related criteria satisfaction module 52 with information on users' individual progress. In particular, each module 68 provides the service related criteria satisfaction module 52 with information for identifying a user 36 that satisfied his/her service related criteria, and information identifying a user 36 that did not satisfy his/her service related criteria (and for which the user should have to pay for accessing the user-funded service). Accordingly, the user-funded service 24 provides service related criteria satisfaction/dissatisfaction information to the manager 64 for storing in the user's data of the user database 48.

Regarding the prize-winning service(s) 28 in more detail, each such service 28 provides one or more contests that qualified users 36 may enter. Each such service 28 has at least one associated user-funded service 24 from which users 36 that satisfy the service related criteria for this associated service may elect to participate in a contest offered by the prize-winning service 28. Each contest preferably provides prizes to winners of the contest, and such prizes are of a sufficient value to motivate users 36 to both satisfy the service related criteria, and then win the contest. Each prize-winning service(s) 28 obtains its eligible users 36 from the service related criteria satisfaction module 52 (via the manager 64). Moreover, the results of each contest (at least identifications of the winners, but in some embodiments, also those that did not win) are also communicated to the module 52 via the manager.

Regarding the service related criteria satisfaction module 52, this module may determine whether a winner of a prize-winning contest is eligible to collect his/her prize. In particular, the module 52 may determine whether a winning user 36 has enter the contest more than a legitimate number of times.

Regarding the user database 48, the database may include the following fields for each user 36:
(a) User 36 identification, including user legal name, a display name, user address, email address, date of birth, credit/debit card information.
(b) Identification of each user-funded service agreement to which the user is obligated to satisfy certain criteria or pay for accessing the corresponding user-funded service 28, such identification including the amount that may be required to be paid for the service, and the amount (if any) already paid.
(c) For each user-funded service agreement to which the user is obligated, the amount (if any) paid/pledged by a sponsor (e.g., an advertiser) to allow the user 36 to access the user-funded service.
(d) For each user-funded service which the user is accessing, an indication of his/her progress toward satisfying the corresponding service related criteria.
(e) Information identifying the prizes that have been won by the user 36.

Regarding the services database 72, this database is accessed by the prize-winning service(s) 28 (via the manager 64) for adding information on prize-winning contests when they become available for participation by users 36, and for deleting information on prize-winning contests when such contests are no longer available to be entered by users 36. Moreover, this database may include information on the prizes of contests, e.g., how/who provided a prize for a contest, the value of the prize, the number of users 36 in the contest, the minimum and/or maximum number of users 36 for the contest etc.

Regarding the advertising database 60, this database may include advertiser information as disclosed in the U.S. Pat. No. 6,712,702 fully incorporated herein by reference for a corresponding advertiser database.

The following pseudo-code may be performed by an embodiment of the compensation model 20 (together with one or more corresponding user-funded service(s) 24 and/or one or more corresponding prize-winning service(s) 28):
Receive user registration information via a network (e.g., the Internet or an intranet) site for obtaining access to one or more services, wherein (i) each user agrees to be bound to the rules for the service(s) offered; (ii) the user provides identification information to certify his/her identity; (iii) the user provides financial information for compensating the operator of the site in the event that the user does not appropriately satisfy certain predetermined service related criteria.
If one or more advertisers contract to sponsor users by paying any potential fees, allow advertisers to select the users for which they can assume the obligation for paying any potential user fees.
If a user is selected by an advertiser for sponsoring, then present to the user the advertiser's willingness to sponsor the user, and let the user select from among one or more advertisers for being sponsored, wherein advertising by the selected advertiser sponsor(s) is also to be presented to the user when one of the one or more services is accessed by the user.
When the user accesses (interacts with) one of the services,
   Determine advertising to present to the user, wherein such advertising is determined based on: (i) whether the user was sponsored by an advertiser(s), (ii) other advertisers who have contracted to have advertising presented to users (e.g., via a third party advertising entity such as Doubleclick or Google). Note, user profiling can be performed for determining advertisements to be presented. In particular, the following user information may used for determining advertisements:
      (a) Since the user is accessing a particular service(s) and has gone to the trouble registering for the service(s), the user is likely interested in advertisements related to the service(s) that he/she can access via such registration;
      (b) The general geographical location of the user is available in many contexts, and in particular, for the Internet, wherein such geographical location information can locate the user to a resolution of approximately corresponding to zip code. One such service providing such location enabling information is available from Quova at www.quova.com, and the following U.S. Pat. Nos. 7,072,963 and 6,684,250 are fully incorporated herein by reference;
      (c) If authorized/permitted, e.g., by the user, read the user's Internet cookie file for identifying other network sites visited by the user, and in particular, comparing various versions of the user's cookie file for determining subject matter that may be frequently accessed by the user, and thus using a correspondence between subject matter of advertisements and the network sites visited by the user;
      (d) Providing the user with, e.g., browser plug-in software providing a capability to: (i) manually terminate a currently presented advertisement, e.g., the user may provided with a graphical button that may be clicked on so that the user can activate the plug-in to terminate a particular advertisement from being presented (and/or re-presented), or (ii) “select an alternative” advertising category, wherein the user is allowed to select advertising categories from which advertising is to be received. Thus, if the user receives a beverage advertisement, the user may select alternative advertisement related to automobiles;
      (e) Monitoring how the user interacts with the service(s) for which he/she registered.

```
Monitor the user's progress toward satisfying the agreed to service
related criteria; and
If the user satisfies the service related criteria then {
Inform the user of such satisfaction;
Identify the user as being eligible for entering one or more
    (if any) instances of prize-winning services;
Store data identifying that the user has satisfied the service
  related criteria;
If the user has paid upfront for any portion of the service
  then {
  Determine how to refund/reimburse the user for his
      payment (e.g., credit card refund,
      providing the payment for a different
      service, etc.);
  Refund/reimburse the user;
}
Else { /* The user has not paid for any portion of the
  service */
  If a sponsor(s) paid for (is obligated to pay for) at
    least a portion of the user's service fee then
    {
      Inform each sponsoring advertiser of
        such satisfaction of the
        service related criteria;
      Store data indicating that the sponsor
        does not have to pay for the
        service;
    }
    If the user is obligated to pay for the service
    then
    Store data indicating that the user does not
      have to pay for the service;
  }
    If the current service being accessed can be
    continued to be accessed by the user then {
      If there is a next more advanced level of the
      service then {
        Ask the user if he/she wishes to
        advance to the next level of the
        service;
        Advance the user if requested to do
        so, otherwise do not;
      }
  }
  Else /* the user has not satisfied the service related criteria
  */
    Periodically (e.g., every week) inform the user of
      his/her unsatisfied service related criteria;
Monitor any time constraints within which the service related
criteria must be satisfied; e.g.,
If a time constraint has expired, then {
  Inform the user of such expiration, and that he/she has not
    satisfied all the service related constraints;
  If the user has not satisfied the service related criteria then
  {
    Identify the user as being ineligible for entering one
      or more (if any) instances of prize-winning
      services corresponding to the user-funded
      service for which the service related criteria are
      applicable;
    Store data indicating that the user has not satisfied
      the service related criteria;
    If the user has paid upfront for any portion of the
      service then
        Release the payment for use by the operator
            of the site;
      Else { /* The user has not paid for any portion of
        the service */
        If a sponsor(s) paid for (is obligated to pay
          for) at least a portion of the user's
          service fee then {
            Inform each sponsoring
              advertiser of such
              non-satisfaction of the
              service related
              criteria;
            Store data indicating that the
              sponsor must pay for
              the user's access to
              the user-funded
              service;
          }
          If the user is obligated to pay for the
          service then
          Charge the user's credit card for any
            remaining portion of the service
            fee still remaining unpaid;
        }
    }
For each prize-winning service instance available DO {
  Determine users that are eligible to access the prize-winning
  service instance, this step including:
  For each user whose eligibility is known, e.g., due the user
    satisfying the related criteria for an associated user-funded
    service instance DO
    Notify the user that he/she can enter the prize-winning
      instance;
  For each request from user's requesting entry into the prize-
    winning instance DO {
    If the user is known to have satisfied the service related
      criteria for an associated instance of a user-funded
      service instance then
      Enter the user into the prize-winning service
        instance;
    Else {
      If other users can enter then
      Determine and store the user's qualification
        information for entering the prize-winning
        instance;
    }
    }
  Conduct the prize-winning service instance.
}
```

Email notification may be used to notify a user of where the user stands in satisfying service related criteria for an instance of a user-funded service (e.g., a game), and/or for an instance of a prize-winning service instance. Moreover, such notification may be transmitted to the user's phone or cell phone. Additionally, an Internet feed and/or instant message may be used to also allow a user to access the user-funded and/or prize-winning service (e.g., blackjack, poker, and/or chess). For example, a user might play a game while in a motor vehicle, and might even receive prizes or some type of “comps” for playing. Voice recognition may also be used to allow the playing of games in an efficient manner, e.g., in a motor vehicle or other environment where the user's communication device available for receiving speech/voice commands (e.g., a mobile phone). For instance, if a user is playing blackjack while in a motor vehicle, words and/or phrases such as “hit me” or “fire” may be used, since it is well within the state of voice recognition technology to readily recognize such simple phrases.

For a service (e.g., a game) being offered on a network, such as the Internet, wherein the interactions are essentially verbal by the user, the network site providing the service, in one embodiment, may user speech recognition processing and may also use text analysis processing. Text analysis processing is for recognizing a textual conversion of spoken dialogue for determining the actions requesting to be performed by a user. The text analysis functionality of the network site preferably includes identifying words and/or phrases and/or sentences that instruct the network site (e.g., a website) that then takes predetermined actions, and in performing such actions, the network site provides feedback to the user verifying the action(s) performed, either prior to or immediately after the action(s) is to be performed. For a user to play a game substantially verbally, game plays may be made by the user via spoken text or speech and such speech is translated into a stream of text transmitted to the network site, the network site then performs text analysis for determining a next game configuration requested by the user. Upon determining the likely user request, the network site then preferably acknowledges to the user the action(s) to be performed, and requests confirmation from the user to perform the action (e.g., the game play).

In one embodiment the network site may instruct the user regarding the words, phrases and or sentences which the network site recognizes for performing actions such as game plays (or other actions for other services). Alternatively/additionally, the user may be able to use conventional speech without the network site providing predetermined speech patterns that the user must provide for the network site to perform particular actions. Accordingly, the network site processes user input and attempts to determine standard actions that are typically spoken to perform the service. For example, in blackjack when playing a game substantially verbally, the user may use the following phrases without being taught or without these phrases being specified by a blackjack playing website: “hit, stand, stay, double down, split, surrender” whereas in poker, the words “raise, ante, fold, see you” may be standard.

The present method and system for receiving compensation for network services provides numerous benefits over prior art business models for receiving compensation, including the following benefits.
(a) The present compensation model provides incentives for users to increase their skills at the service (e.g., playing a game, designing a landscape, teaching the user to fly an airplane, teaching the user how to invest in the stock market, etc.).
(b) It is believed that even small fees will cause users to disproportionately increase their interest in using the service since users have a invested interest in the service, and can be get their investment back if they enhance their skills. Accordingly, the present compensation model pays users to become more skilled, and it is believed that users will recognize the benefits of the present compensation model for them, and thus develop greater loyalty to the network site using the present compensation model.
(c) It is believed that users will tolerate advertising being presented even though they have paid for the service since there is the expectation that the service is ultimately free when they satisfy certain service related criteria (e.g., reach a particular proficiency level) for them to not be charged and/or their activation fee or deposit to be refunded. Thus, the operator of the network site can obtain advertising revenue and user revenues for the same service.
(d) By requiring users to be responsible for paying an activation fee or deposit (which may be as low as, e.g., $1 or less), users must identify themselves, e.g., via a credit or debit card or some other financial transaction instrument. Accordingly, for a service such as a game tournament with the subsequent opportunity to win substantial prizes, duplicate entries by a user may be detected. That is, in using a credit or debit card, a user is required to input his/her name, address, and credit card number. Accordingly, a user having the same last name, and the same address as another user, may be asked for additional information for distinguishing the two users such as whether the user is male or female, and/or date of birth. Moreover, all users may be requested to declare that they have only entered such a tournament once, and when a user wins a prize, the present compensation model may perform additional checks for further assuring that the user has not entered multiple times. Accordingly, the use of such financial transaction information for providing greater integrity and fairness to the service (particularly, competitive services such as games or contests) is believed to be an important benefit of the present compensation model. Moreover, perceptions of integrity can be extremely important for network sites and the services they provide since the inherent lack of personal contact between communicating parties is not particularly conducive to assuming a service is impartially or fairly operated.
   In an alternative embodiment, some services may not require rigidly monitoring or assuring a single entry per user to a particular service (or instance thereof). Accordingly, in such circumstances, the activation fee or deposit may be increased to a level that generally inhibits a user from activating the service under multiple identifications or aliases since both a separate activation fee or deposit would be required for such user identification or alias.
(e) The use of proficiency levels can add integrity or fairness when users are in competition with one another. For example, before a user enters such a service multiple times for substantially increases his/her odds of winning (free) prizes, the user would have to demonstrate a particular proficiency level under each of the user's aliases. Thus, the demonstration of proficiency levels may be, by itself, a deterrent to a user entering such a service multiple times.
(f) The present compensation model can provide additional revenue to the operator of a network site since at least some users, if not most of the users, may not satisfy certain service related criteria (e.g., reach the predetermined proficiency level), and accordingly, the operator retains the users' activation fees or deposits.
(g) The service related criteria (e.g., proficiency level) can be adjusted and/or tailored to the needs of the operator of the network site. For example, an operator of a network site that derives (or intends to derive) its revenues from advertising may set the service related criteria (e.g., proficiency level) for the service, e.g., a game (or games), at a sufficiently high level so that users activating the service are exposed to a large number of ads while attempting to satisfy the service related criteria (e.g., reach the proficiency level). Moreover, if the service related criteria includes, e.g., a length of time the service must be activated/utilized, and/or a predetermined number of service instances activated (e.g., a number of game instances played), then the operator has greater assurance that the advertisement expectations of the operators advertisers will be satisfied. Furthermore, if the service related criteria is sufficiently high such that many of the users do not satisfy the service related criteria, then the site operator retains the users' activation fee or deposit.
   Alternatively, if the operator wishes to derive revenue from offering coupons of advertisers, and/or inexpensive items of advertisers, then the service related criteria may be made low enough so that most users satisfy the service related criteria, and subsequently the users may be given the option of selecting one or more coupons and/or sponsor items in addition to, or in lieu of all or a portion of their activation fee or deposit. Moreover, since users satisfying the service related criteria will be provided with the opportunity to win additional, e.g., more substantial, prizes for free, users are likely to tolerate subsequent advertising during instances of the service for which such additional prizes may be won. Additionally, user selection of particular coupons and/or items as part of their refund (and/or in addition to their refund) provides additional information about the users, and such information can be associated with the users' identities for presenting to such users additional advertising, coupons, and/or sponsor products/services that is likely to be of interest to the user.

If a fee is to be returned or refunded, instead of the fee being returned immediately, such fee may also be transferred by either the player or the site to another game, website, or another entity as agreed or as set forth in a predetermined agreement an operator of a network site providing (at least a portion) of the services for the compensation model.

In one embodiment, the user activation fee or deposit may be reduced if the user is identified by one or more other users as a user that motivated them to register for a user-funded service.

The advertising necessary to inform potential users of a network site that utilizes the present compensation model may be spread by word of mouth, and/or various social networking sites. However, to facilitate awareness of such network sites, ads for such network sites may be placed upon disposable mats. In particular, such mats may provided in dressing rooms and other locations. where people are concerned about their feet touching a floor due to concerns for cleanliness or the fear of contracting a foot disease/infection. Such mats may have a water repelling surface on at least one of the sides and a germicide provided on the surface on the side that the user is to place his or her feet. Advertising may be placed upon at least one of the mat sides. The mats may be precut to a size large enough for a person's feet to avoid touching a floor's surface or the mat may be dispensed by using an “endless” roll—or a roll from which many mats may be dispensed with the aid of perforations at various locations in the roll so that advertising mats may be used in said dressing rooms. Alternatively, such foot mats may be available in a plurality of sizes (e.g., similar to shoe sizes). Moreover, such foot mats may be secured to a person's foot via straps that adhesively adhere to one another or to the mat. The mats may be provided at little or no cost. Embodiments of such mats may be also used for “place mats” upon which food may be placed. The advertising mats may also be made of a material and size that allows them to adhere to shirts or other material such as bed sheets. Additionally, such advertising may be provided in the form of stencils for placement upon bedding or wearing apparel, wherein such bedding or apparel may be provided at little or no cost to the public and/or a third party.

The foregoing discussion of the invention has been presented for purposes of illustration and description. Further, the description is not intended to limit the invention to the form disclosed herein. Consequently, variation and modification commiserate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention.

What is claimed is:

1. A method for compensating a network service provider, comprising:
Providing a user-funded service for a network user to access;
Establishing a criteria for the user to satisfy;
When the user satisfies the criteria, providing the user with access to the prize-winning service.
